(19) United States
(12) Patent Application Publication
(10) Pub. No.: US 2011/0076637 A1
(43) Pub. Date: Mar. 31, 2011

(54) DEVICE FOR REDUCING PATHOGENIC MICROBES

(76) Inventors: Paul Schaffrath, Heidesheim (DE); Valerie Kuppfer, Mainz (DE)

(21) Appl. No.: 12/995,356

(22) PCT Filed: May 28, 2009
(86) PCT No.: PCT/DE09/00743

§ 371 Date: Nov. 30, 2010

(30) Foreign Application Priority Data
May 30, 2008 (DE) 10 2008 026 067.3

(51) Int. Cl. A61C 19/06

(52) U.S. Cl. 433/32

(57) ABSTRACT

The invention relates to a device that is simple to operate, for reducing pathogenic microbes using the antimicrobial effects of silver ions, without engaging additional medicinal treatment, for effectively treating the human body in case of illness or as a preventive measure. The aim is achieved by a device comprising a handle, a negative pole coming into contact with the body, and a device head having a positive pole, so that a low electrical voltage is generated between the poles, wherein at least the positive pole is made of silver, giving off positive ions into the body tissue when the circuit is closed.

The invention relates to a device for reducing pathogenic microbes.

A multiplicity of different bacteria colonizes on and in the human body. The oral cavity is one of the main entry sites for pathogenic agents such as bacteria and fungi.

Up to now, these pathogenic agents have been treated more or less successfully in the event of a disease with, for example, antibiotics and antimycotics, in which case secondary effects, intolerances, and resistances always occur as unwanted side effects.

With more or less all antibiotics, gastrointestinal disorders such as nausea, vomiting, diarrhea are, inter alia, very common. Allergic reactions too are widespread and even prohibit in many cases an antibiotic treatment of the patient concerned.

In the human oral cavity are, for example, numerous bacterial strains whose metabolic and degradation products cover the teeth as bacterial plaques. Through the presence of the plaques, the body's own defensive responses are triggered against the bacteria colonizing in the oral cavity, in which case there is release of, inter alia, enzymes which attempt, without success, to destroy the bacteria and to prevent penetration of the microorganisms into deeper tissue layers, but instead result in destruction of the body's own tissue. Here, the bacteria are protected from the effect of antibiotics by a biofilm.

Thus, even the daily implementation of oral hygiene can, through the side effects of the body's own immune response, result in inflammations in the oral cavity, for example, resulting in gingival bleeding, periodontitis, breakdown of bone, etc., eventually resulting in irreversible destruction of the periodontium.

Periodontitis, a bacteria-induced inflammation of the periodontium with gradual breakdown of the jawbone, is a widespread disease, with about 80% of all Germans being affected by periodontitis at various levels of severity.

A thorough cleaning of the teeth, comprising removal of tartar and plaque, is usually recommended for periodontitis therapy. Since more particularly the accumulation of bacteria in so-called gingival pockets is problematic, treatment of periodontitis is routinely supported by the administration of antibiotics which are either introduced locally into the gingival pocket or administered systemically, for example, as tablets. The primary goal is the rapid reduction of the number of bacteria in the oral cavity of the patient.

In the mouth, other pathogenic microbes can, however, also result in common diseases such as herpes, aphthous ulcers, or mycoses.

A medicamentous therapy is invariably the most commonly applied method to date for healing in the case of a high risk of recurrence.

Another example is the wide prevalence of vaginal mycoses or vaginal bacterial infections. Antimycotics or antibiotics are also used here, with the unwanted consequences described above. A biofilm surrounding the bacteria impedes the effect of antibiotics here as well.

The disadvantageous consequences of routine administration of antibiotics are well known; more particularly, the increasing resistance of numerous bacterial strains to commonly used antibiotics is very problematic here.

Aside from the antibiotics already mentioned, an antibacterial effect can also be achieved by, for example, silver ions. Thus, silver was already used in antiquity for disinfecting wounds or for keeping water and food fresh.

This antibacterial effect of silver is explained by the release in a wet environment of silver ions which attack and destroy the cells walls of bacteria in the proximity. Thus, silver has an antibacterial effect which can be applied practically free of secondary effects.

Use is known from, inter alia, the document DE 29803277 U1 of so-called tongue cleaners which are made of silver and which are scraped over the surface of the tongue, whereby the number of bacteria colonizing on the tongue is distinctly reduced.

Use is also known of toothpastes or mouth washes and toothbrushes which comprise silver. For example, DE 19508539 proposes a toothbrush with filaments of elastic synthetic material comprising, inter alia, silver particles which release silver in ionic form under the influence of saliva.

This results in a toothbrush that contains no microbial films, even after extended brush usage.

Synthetic bristles comprising silver particles of different particle sizes for use in toothbrushes are also already known from DE 101 45 275.

However, it is a disadvantage here that the manufacture of such specific toothbrushes with silver particles incorporated into the filaments is cost-intensive.

Aside from the described use in toothbrushes, the use of silver ions for antibacterial surfaces of synthetic materials is also known, for example, in certain light switches and door handles in clinics, in washing machines, bandages, or as woven-in silver threads in sports clothing, and also, inter alia, as a constituent of wall paint against mold formation.

The processes, applied to date, of incorporating silver particles into a polymer matrix are, however, technically complex and difficult.

In all the abovementioned apparatuses and processes, the silver ions, which go into solution through contact with moisture, act directly on the silver and tissue surfaces. However, an effect in deeper tissue layers is not achievable this way.

Achieving the transport of active ingredient into a tissue by means of iontophoresis is known, inter alia, for obtaining in general an effect of a medicament not only on the tissue surface but also for achieving an effect deep in the tissue.

Here, under the influence of a weak direct current, active ingredients are dissolved in a liquid channeled into the skin, in which case the active ingredients must be present as ions, i.e., as charge carriers in their own right, so that they can be transported in the electrical field. The strength of the electric current is so low here that the patient feels at the most a slight tingling sensation.

Known applications of iontophoresis are, for example, the improvement of the penetration of antirheumatic ointments into the skin or the treatment of hyperactive sweat glands by means of direct current in a water bath.

An iontophoresis device with which hypersensitive dentin of a tooth is treated by the application of specific liquids is known from, for example, WO 02/19941 A1.

The patient holds in his/her hand a more or less rod-shaped device which contains inside a current source and also a cartridge which is filled with medicinal active ingredient in liquid form and which is applied via a head end onto the surface of the teeth in the mouth. As soon as the head end touches the tooth, the electric circuit is closed via the arm of the patient and the active ingredient is channeled into the tooth.

U.S. Pat. No. 3,520,279 A describes an iontophoretic-acting toothbrush which takes advantage of the differing conductance of different metals in its head area in order to transport active ingredients of the toothpaste into the inner tooth. The material silver is also mentioned here as a known good electrical conductor.

In order to transport in principle the active ingredient as close as possible to the seat of disease by iontophoresis, specifically shaped devices are also known which are used more particularly in the oral cavity for treating periodontitis.

By way of example, reference is made here to the U.S. Pat. No. 3,502,076 A, which discloses a mouthpiece in the shape of a specific dental impression with a sponge, with liquid medicaments being transported into the interior of the teeth and the jaw by means of iontophoresis via the mouthpiece. The electric circuit is closed here via the body of the patient.

DE 2839968 C2 also discloses a specifically formed U-shaped track in the oral cavity, carrying both electrodes at its opposite branches so that the current flows only in the mouth and not through other body parts. Furthermore, the direction of current flow can be reversed. A liquid active ingredient is in turn accommodated in the track, and therefore this device also serves to transport active ingredient into deeper tissue layers by iontophoresis. It is proposed to use silver, inter alia, as electrodes owing to its known good conductance.

A disadvantage of known iontophoresis devices is that a medicament is invariably channeled into the diseased tissue, i.e., in the event of a disease, treatment is with a medicinal active ingredient to which the human body reacts in most cases with secondary effects or resistances upon application over a longer period of time. A possibly antimicrobial effect of the electrodes used does not play a role in iontophoresis. Of importance here is only a good conductance, which the metal silver, for example, also exhibits.

In summary, the mechanical methods or medicamentous therapies known and applied to date are not sufficient to achieve a truly long-lasting reduction in the number of disease-causing microbes on and in the body, whereby the body's own immune defense, which damages the body's own tissue, could also be weakened.

Accordingly, it is an object of the present invention to produce a simple-to-operate device for reducing pathogenic microbes, taking advantage of the antimicrobial effect of silver ions without additional medicamentous treatment, so that it is possible for practically everyone to carry out an effective treatment on their own body as a prophylaxis, for example, periodontal prophylaxis in daily dental care, or else in the event of a disease, without having to continuously ingest or apply a medicament.

This is achieved according to the invention by a device with the features of claim 1.

Advantageous embodiments are specified in the subclaims.

In the figures, advantageous designs of the invention are illustrated and described in detail.

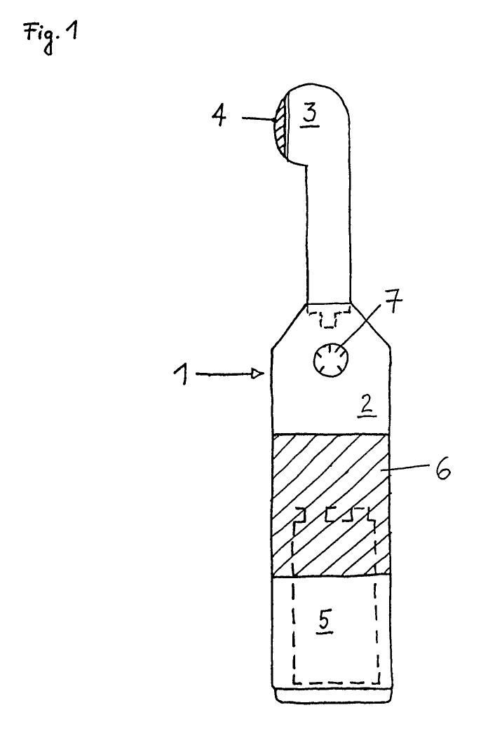

FIG. 1 shows the device according to the invention, by way of a roughly life-sized diagram, with a silver layer at the positive terminal in the device head, and

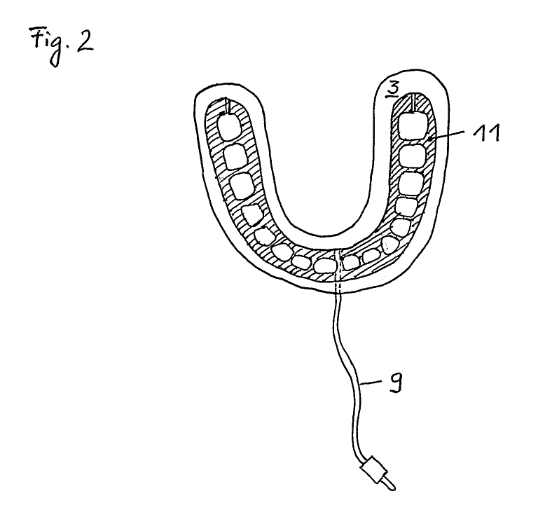

FIG. 2 shows an overhead view of a specific head section of the device according to the invention for use in the mouth, and

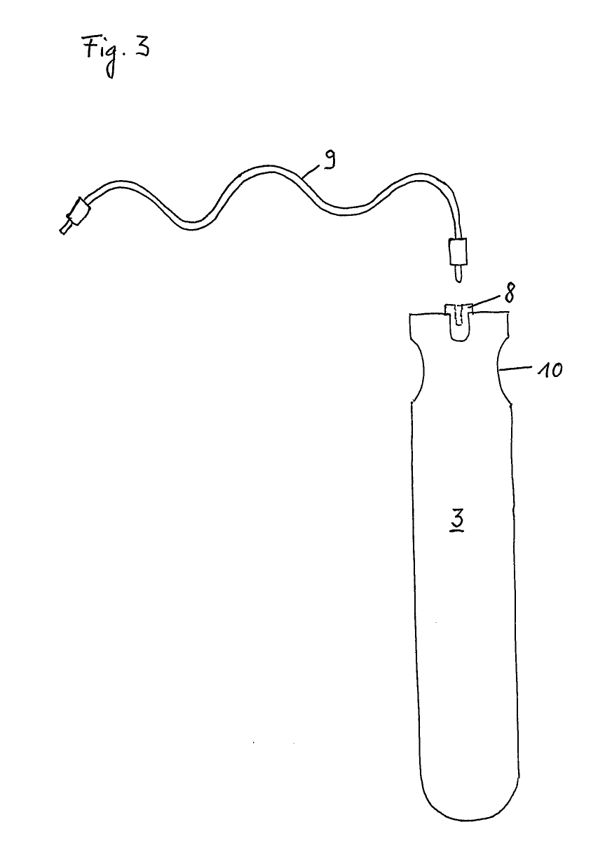

FIG. 3 shows a specific head section, designed as a vaginal probe, of the device according to the invention.

The device 1 according to the invention which is depicted in FIG. 1 consists of a casing 2 of sterilizable synthetic material or stainless steel, an internal current source 5, and a replaceable synthetic material head 3 with a preferably round or elliptic silver electrode 4 as a positive terminal. The device 1 shall, for example, be held by patients with their right hand, with the hand tightly clasping the conductive midsection (negative terminal) 6 of the casing 2.

The patient then introduces the device head 3 into his/her oral cavity and begins to uniformly massage, not only from inside and outside but also from above and below, the gingiva, more particularly the gingival margins on the teeth, with the silver electrode 4, acting as a positive terminal and having the conductive silver foil, coming to lie directly on the gingiva.

By means of contact with the moist gingiva, a low current roughly in the range of 0.5 mA, which is not perceptible if at all, flows through the arm of the patient from a battery 5 accommodated within the device, i.e., the electric circuit is closed, and silver ions are released at the positive terminal 4 in the device head 3. The tongue or the buccal mucosa can be treated in the same way.

An electronic control system, which is not depicted, provides a steady flow of electric current and prevents overvoltage, for example, upon contact with a metal restoration in the oral cavity.

There is also the possibility to control the strength of the electric current via a controller 7.

The released Ag⁺ ions of the silver electrode 4 in the device head 3 bind to the outer cell wall of the bacteria located in the oral cavity and irreversibly damage the bacterial cells. Further medicaments which are invariably used in classical iontophoresis and have secondary effects are not used with this device according to the invention.

FIG. 2 shows a specific device head 3, intended for treating more particularly generalized periodontitis, in the form of a more or less jaw-shaped and, in cross-section, more or less U-shaped track. This specific device head is preferably produced on an individual basis.

The device head 3 is connected to the handpiece 2 of the device 1 via a cable 9. The device head 3 consists here of an inner layer of 0.999 fine silver 11 which directly covers the marginal gingiva completely circumferentially up to the tooth necks, with the silver layer being at least as wide as the previously measured gingival pockets.

The fine silver layer 11, which, as a positive terminal, releases the silver ions upon the flow of electric current into the gingiva, lies along the inner and outer gingival margin on the inner surface of a more or less U-shaped track of, for example, flexible synthetic material or silicone. As a result, the silver 11 is insulated with respect to the oral cavity and the teeth, and an exact lining of the silver layer 11 on the gingival borders to be treated is provided for.

This specific track is produced on an individual basis for the upper jaw and lower jaw and is so flexible that it can be inserted over the equator of the teeth.

The patient holds as before the device grip (negative terminal) 2 in his/her hand, but has the advantage of simultaneous treatment of the entire jaw without having to treat individual areas separately.

Through the mode of action of the device according to the invention, a routine and long-lasting elimination of pathogenic bacteria which are, for example, responsible for periodontitis is possible, and without allergic reactions, development of resistances, or the known secondary affects of antibiotics.

This effective elimination of bacteria can be carried out by every patient without any problems through integration into domestic oral hygiene and can also be carried out during the course of professional cleaning of teeth at the dentist. Accordingly, it is possible to have both basic models of the device for domestic use with an integrated voltage source, such as in electric toothbrushes, and devices which are for professional use by dentists and dental assistants and which included, optionally, an external power supply and further structural features such as, for example, external positioning of the negative terminal as a metal part which the patient holds in his/her hand, connected to the device via an insulated cable, and also replaceable and sterilizable device head ends of different shapes and sizes which are required for professional use of the device.

The silver layer, at least at the positive terminal, can be designed as a thicker silver layer or else as a replaceable, thinner silver foil for single use.

Owing to the fact that silver ions already have a high antimicrobial effect at very low strengths of electric current, i.e., can be applied effectively not only against bacteria but also against fungi and viruses, the device according to the invention can be used practically at any site in and on the human body, provided at least the silver positive terminal fits as precisely as possible to the site of the body to be treated, and therefore the head end must be specifically shaped for each application.

FIG. 3 shows a specific head section 3 of the device according to the invention 1, which is designed as a more or less cylindrical vaginal probe and which is connected to the hand grip (negative pole) of the device 1 via a socket 8 and a cable 9. At one end, the vaginal probe 3 is shaped as a further grip 10.

This specific head section 3 can be designed in different sizes and is advantageously sterilizable, so that it can be applied many times. It is essential that the head section 3 consists either completely or partly of silver which comes into contact with the inner mucosa and releases antimicrobially effective silver ions upon electric current flow.

In principle, similarly shaped vaginal probes without silver are used in medicine with a stimulatory current, for example, for strengthening the muscles of the pelvic floor, but the use of antimicrobially effective silver ions here is not known.

Since silver ions also prevent certain cancer cells from dividing, a use in this direction is also possible, for example, for cervical cancer, or by means of an appropriately shaped rectal probe for colon cancer and prostate cancer.

It has been proven from numerous studies that silver ions act effectively against all known pathogenic bacteria and also fungi and viruses without their being able to develop resistances to silver ions. Intolerances or allergies to silver are not known. The only secondary effect described to date is, in the case of too high an uptake of silver, a gray discoloration of the skin or mucosa (argyria), which was observed, for example, after ingestion of silver-containing medicaments or with the use of silver-containing makeup. The gray coloration is attributable to the incorporation of silver-colored granules into the skin. The threshold value for argyria is reached by the intravenous uptake of 1 mg of silver per day (adult, 70 kg).

Such a high uptake of silver into the body, as would be necessary for argyria to occur, is not reached in any way by means of the device according to the invention. In the case of a 20-minute application of the device according to the invention, the absolute uptake of silver is about 1 μg at 0.5 mA.

Through the effectiveness of the device according to the invention on pathogenic microbes without the known disadvantages such as secondary effects, allergies, resistances, application limitations, and intolerances, which inevitably occur with the ingestion or application of medicaments, the user receives the possibility of an effective, simple, and cost-effective prophylaxis and therapy with success in the long run and without strain on the health of his/her body.

1-19. (canceled)

20. A device for reducing pathogenic microbes, comprising a hand grip, a negative terminal coming into contact with the body, and also a device head with a positive terminal, wherein a low electrical voltage is generated in the device between the terminals,
which comprises:
at least the positive terminal consists of silver, which releases positive ions into the body tissue upon closing the electric circuit.

21. The device for reducing pathogenic microbes as claimed in claim 20,
wherein
at least the positive terminal consists of 0.999 fine silver.

22. The device for reducing pathogenic microbes as claimed claim 20,
wherein
at least the positive terminal consists of a replaceable silver foil.

23. The device for reducing pathogenic microbes as claimed in claim 20,
wherein
the hand grip of the device contains in its midsection a conductive zone acting as a negative terminal,
and a silver layer is arranged as a positive terminal in the device head of the device,
and a current source is accommodated within the device.

24. The device for reducing pathogenic microbes as claimed claim 20,
wherein
the device head of the device is detachable and replaceable, wherein the device head is attached to the device via a metal plug connection.

25. The device for reducing pathogenic microbes as claimed in claim 20,
wherein
the device head of the device is connected to the hand grip via sockets and cables and, thus, can be applied away from the hand grip.

26. The device for reducing pathogenic microbes as claimed in claim 20,
wherein
there is an arrangement on the device of two sockets, one of which is connected to the cathode of the interior voltage source and the other one is connected to the conductive zone in the hand grip.

27. The device for reducing pathogenic microbes as claimed in claim 26,
wherein
both sockets on the device are bridged electrically by a person during use with his/her own hand, whereby, upon touching the conductive zone in the hand grip, the electric circuit is closed via the arm of the person using the device as soon as the device head of the device gets into contact with the body of said person.

28. The device for reducing pathogenic microbes as claimed claim 20,
wherein
the device head is designed as a more or less jaw-shaped and, in cross-section, more or less U-shaped track which is connected to the rest of the device via at least one socket and at least one cable and which contains a layer of silver on the inside along the gingival margin.

29. The device for reducing pathogenic microbes as claimed in claim 28,
wherein
the track-shaped device head consists of flexible synthetic material or silicone.

30. The device for reducing pathogenic microbes as claimed claims 20,
wherein
the device head of the device with at least the positive terminal made of silver is more or less rod-shaped.

31. The device for reducing pathogenic microbes as claimed in claim 30,
wherein
the more or less rod-shaped device head is detachable and replaceable and is connected to the rest of the device via at least one socket and at least one cable, wherein a further grip is arranged at one end of the more or less rod-shaped device head.

32. The device for reducing pathogenic microbes as claimed claim 20,
wherein
at least the device head of the device consists of sterilizable material.

33. The device for reducing pathogenic microbes as claimed in claim 20,
wherein
the voltage source is rechargeable and has a separate charging station.

34. The device for reducing pathogenic microbes as claimed in claim 20,
wherein
the device has an electronic control system for avoiding overvoltage upon contact with metal restorations in and on the body.

35. The device for reducing pathogenic microbes as claimed in claim 20,
wherein
a timepiece is arranged on the device.

36. The device for reducing pathogenic microbes as claimed in claim 20,
wherein
a battery charge display for the voltage source is arranged on the device.

37. The device for reducing pathogenic microbes as claimed in claim 20,
wherein
a potentiometer for controlling voltage is arranged on the device.

38. The device for reducing pathogenic microbes as claimed in claim 20,
wherein
the device is provided with voltage via an external controllable voltage source.
